(19) United States
(12) Patent Application Publication
(10) Pub. No.: US 2018/0217693 A1
(43) Pub. Date: Aug. 2, 2018

(54) TOUCH SCREEN, DISPLAY DEVICE AND MANUFACTURING MTHOD OF TOUCH SCREEN

(71) Applicant: Wuhan China Star Optoelectronics Technology Co., Ltd., Wuhan, Hubei (CN)

(72) Inventor: Bo LI, Shenzhen, Guangdong (CN)

(73) Assignee: Wuhan China Star Optoelectronics Technology Co., Ltd., Wuhan, Hubei (CN)

(21) Appl. No.: 15/125,186

(22) PCT Filed: Jul. 12, 2016
(86) PCT No.: PCT/CN2016/089781

§ 371 Date: Sep. 12, 2016

(30) Foreign Application Priority Data
Jun. 24, 2016 (CN) 201610475147.5

(51) Int. Cl. G06F 3/044; G06F 3/041

(52) U.S. Cl. CPC G06F 3/044; G06F 3/0412

(57) ABSTRACT

The invention discloses a touch screen including: a glass cover; a functional sheet including a first surface and a second surface disposed opposite to each other and both having electrically conductive function and further being defined with a window area and a wiring area disposed surrounding the window area; an insulating layer, disposed on the second surface and covering the wiring area; and a liquid crystal display panel, attached to both the second surface and the insulating layer by a second adhesive layer. The touch screen of the invention has the advantage of small thickness. Moreover, the invention further discloses a display device and a manufacturing method of a touch screen.

### CROSS REFERENCE TO RELATED APPLICATION

This application claims the priority of Chinese Patent Application No. 201610475147.5, entitled “Touch Screen, Display Device and Manufacturing Method of Touch Screen”, filed on Jun. 24, 2016, the disclosure of which is incorporated herein by reference in its entirety.

### FIELD OF THE INVENTION

The invention relates to the field of touch-sensitive display technology, and particularly to a touch screen, a display device and a manufacturing method of a touch screen.

### BACKGROUND OF THE INVENTION

With the increasing development of electronic products, the application range of touch screen is gradually expanding, and manufacturing technology of touch screen also shows diversity. Current common capacitive touch screen structures include externally-mounted type capacitive touch panel such as G+G (cover glass-sensing layer glass), OGS (monolithic touch panel), GF (cover glass-sensing layer film) and GFF (cover glass-upper sensing layer film-lower sensing layer film), and embedded type capacitive touch panel such as on-cell type (also referred to as a solution of embedding a touch panel function between a color filter substrate and a polarizing plate) and in-cell type (also referred to as a solution of embedding a touch panel function into liquid crystal pixels). Along with the steady improvement of product performance, lightweight and slim products have become an increasingly important trend. Compared with the complexity in manufacturing process of on-cell type and in-cell type, the externally-mounted type capacitive touch panel with GF2 (cover glass-film-XY) structure has mature and stable manufacturing process and thus can support large-sized products.

For the traditional GF2 structured product, because of its special double-sided electrically conductive structure, a mounting surface of the GF2 capacitive touch panel attached to a liquid crystal display panel needs to be added a protective film thereon, e.g., an anti-scattering film (ASF) with an adhesive layer, to protect touching wires. Such solution although can effectively protect the wires, because the anti-scattering film completely covers the mounting surface of the GF2 capacitive touch panel and the anti-scattering film is relatively thick, the anti-scattering film would cause the increase of overall thickness of product as a result.

### SUMMARY OF THE INVENTION

Accordingly, a technical problem to be solved by the invention is to provide a touch screen with a small thickness.

Moreover, a technical problem to be solved by the invention is to provide a display device adopting the touch screen.

In addition, a technical problem to be solved by the invention is to provide a manufacturing method of a touch screen.

In order to achieve the above objectives, embodiments of the invention employ technical solutions as follows.

In one aspect, a touch screen is provided and includes: a glass cover; a functional sheet including a first surface and a second surface disposed opposite to each other and both having electrically conductive function, the first surface being attached to the glass cover by a first adhesive layer, the functional sheet being defined with a window/viewing area and a wiring area disposed surrounding the window area; an insulating layer, disposed on the second surface and covering the wiring area; and a liquid crystal display panel, attached to both the second surface and the insulating layer by a second adhesive layer.

In an embodiment, a thickness of the insulating layer is less than or equal to 10 μm.

In an embodiment, the thickness of the insulating layer is greater than or equal to 5 μm.

In an embodiment, the functional sheet includes a first metal mesh layer, a PET substrate and a second metal mesh layer sequentially stacked in that order.

In an embodiment, the first adhesive layer and the second adhesive layer each are made of an optically clear adhesive material.

In another aspect, a display device is provided and includes the touch screen according to any one of the above embodiments.

In still another aspect, a manufacturing method of a touch screen is provided and includes: preparing a functional sheet, wherein the functional sheet includes a first surface and a second surface disposed opposite to each other and both having electrically conductive function, the functional sheet is defined with a window area and a wiring area surrounding the window area; forming an insulating layer on the second surface, wherein the insulating layer is disposed covering the wiring area; forming a first adhesive layer on the first surface; attaching a glass cover onto a surface of the first adhesive layer facing away from the first surface; forming a second adhesive layer on the second surface and the insulating layer; and attaching a liquid crystal display panel onto a surface of the second adhesive layer facing away from the second surface to thereby form a touch screen.

In an embodiment, the step of “preparing a functional sheet, wherein the functional sheet includes a first surface and a second surface disposed opposite to each other and both having electrically conductive function” includes: providing a PET substrate; forming a patterned first metal mesh layer on a side of the PET substrate in a roll-to-roll manner, wherein the first metal mesh layer has the first surface; and forming a patterned second metal mesh layer on another side of the PET substrate in a roll-to-roll manner, wherein the second metal mesh layer has the second surface.

In an embodiment, the step of “forming an insulating layer on the second surface” includes: printing a patterned insulating layer coating on the second surface in a roll-to-roll manner; and solidifying the insulating layer coating to form the insulating layer.

In an embodiment, the step of “forming a first adhesive layer on the first surface” includes: attaching the first adhesive layer onto the first surface in a sheet-by-sheet manner.

Compared with the prior art, the invention can achieve the following efficacy that: for the touch screen as described in various embodiments of the invention, because the insulating layer is disposed covering the wiring area, wires of the functional sheet are completely isolated from outside and thus product reliability of the touch screen is improved. Moreover, because the insulating layer exposes the window area, the window area of the touch screen can achieve advantages of high light transmittance and good display image quality. In addition, because the thickness of the insulating layer can be controlled in a very thin range, the overall thickness of the touch screen is reduced, which facilitates the touch screen to be light weight and slim. Furthermore, the insulating layer has a low cost, and thus can effectively reduce product cost of the touch screen.

### BRIEF DESCRIPTION OF THE DRAWINGS

In order to more clearly illustrate technical solutions of embodiments of the invention or the prior art, drawings will be used in the description of embodiments or the prior art will be given a brief description below. Apparently, the drawings in the following description only are some of embodiments of the invention, the ordinary skill in the art can obtain other drawings according to these illustrated drawings without creative effort.

FIG. 1 is a schematic structural view of a touch screen according to an embodiment of the invention.

FIG. 2 is a schematic structural view of a functional sheet of a touch screen according to an embodiment of the invention.

FIG. 3 is a flowchart of a manufacturing method of a touch screen according to an embodiment of the invention.

### DETAILED DESCRIPTION OF THE PREFERRED EMBODIMENTS

In the following, with reference to accompanying drawings of embodiments of the invention, technical solutions in the embodiments of the invention will be clearly and completely described. Apparently, the embodiments of the invention described below only are a part of embodiments of the invention, but not all embodiments. Based on the described embodiments of the invention, all other embodiments obtained by ordinary skill in the art without creative effort belong to the scope of protection of the invention.

Moreover, the following description of various embodiments is with reference to accompanying drawings and for exemplarily illustrating specific embodiments which are embodied by the invention. Directional terminologies mentioned in the invention for example “upper”, “lower”, “front”, “rear”, “left”, “right”, “inside”, “outside”, “side surface” and so on only are with reference to directions of accompanying drawings, and therefore the used directional terminologies are used for better and more clearly illustrating and understanding the invention, rather than indicating or implying devices or elements must have specific orientations, and be structured and operated with specific orientations, and therefore cannot construed as limiting of the invention.

In the description of the invention, it is noted that, unless otherwise clearly defined and limited, terms “installing”, “connecting with”, “connected”, “disposed on . . . ” should be broadly understood, for example, it may be fixedly connected, may be detachably connected or integrally connected; it may be mechanically connected; it may be directly connecting with, may be indirectly connecting with by an intermediary, may be internally communicated between two elements. For those ordinary skills in the art, specific meanings of the above terms in the invention can be understood according to specific situations.

In addition, in the description of the invention, unless otherwise indicated, “multiple” means two or more than two. If the specification appears the term “step”, it not only means an individual process, when it cannot distinguish from the other step, as long as it can realize the intended function of the step, it should be included in the term. Furthermore, in this specification, a numerical range expressed by “˜” means a range containing values before and after “˜” respectively as the minimum value and the maximum value. In the drawings, units with similar or same structures are denoted by same reference numerals.

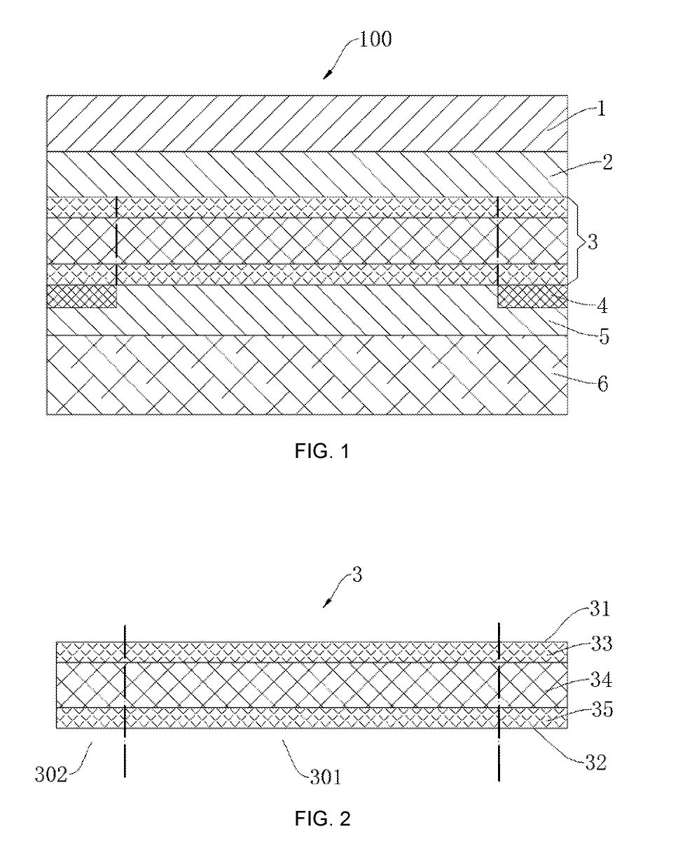

Referring to FIG. 1 and FIG. 2 together, an embodiment of the invention provides a touch screen 100 including a glass cover 1, a first adhesive layer 2, a functional sheet (e.g., sensor) 3, an insulating layer 4, a second adhesive layer 5 and a liquid crystal display panel 6. The functional sheet 3 includes a first surface 31 and a second surface 32 disposed opposite to each other and both having electrically conductive function. The first surface 31 is attached to the glass cover 1 by the first adhesive layer 2. The functional sheet 3 is defined with a window area 301 and a wiring area 302 disposed surrounding the window area 301. The insulating layer 4 is located on the second surface 32 and covering the wiring area 302. The liquid crystal display panel 6 is attached to both the second surface 32 and the insulating layer 4 by the second adhesive layer 5.

In the illustrated embodiment, because the insulating layer is disposed covering the wiring area 302, wires of the functional sheet 3 are completely isolated from outside, and therefore product reliability of the touch screen 100 is improved. Moreover, because the insulating layer 4 exposes the window area 301, the window area 301 of the touch screen 100 achieves advantages of high light transmittance and good display image quality. Meanwhile, because a thickness of the insulating layer 4 can be controlled in a very thin range, the overall thickness of the touch screen 100 is reduced, which facilitates the touch screen 100 to be light weight and slim. In addition, the insulating layer 4 has a low cost, the product cost of the touch screen 100 can be effectively reduced.

It should be understood that, because the window area 301 of the touch screen 100 in the illustrated embodiment is not covered by the insulating layer 4, the touch screen 100 is especially suitable for large-sized (the window area 301 has a large proportion) and thin touch-sensitive display devices.

Further, as an alternative embodiment, the thickness of the insulating layer 4 is less than or equal to 10 μm, so that the overall thickness of the touch screen 100 is small.

Preferably, the thickness of the insulating layer 4 is greater than or equal to 5 μm. That is, an optimal thickness range of the insulating layer 4 is from 5 μm to 10 μm.

Still further, referring to FIG. 1 and FIG. 2 together, as an alternative embodiment, the functional sheet 3 includes a first metal mesh layer 33, a PET (Polyethylene terephthalate, its chemical formula is COC6H4COOCH2CH2O) substrate 34 and a second metal mesh layer 35 sequentially stacked in that order. At this situation, the first metal mesh layer 33 has the first surface 31 and the first surface 31 is facing away from the PET substrate 34; the second metal mesh 35 has the second surface 32 and the second surface 32 is facing away from the PET substrate 34. Meanwhile, because the touch screen 100 employs the PET substrate 34, the touch screen 100 is a flexible touch screen.

Even still further, as an alternative embodiment, the first adhesive layer 2 and the second adhesive layer 5 both are made of an optically clear adhesive (OCA) material, so that the first adhesive layer 2 and the second adhesive layer 5 both would not degrade the image display quality of the touch screen 100. Moreover, because the first adhesive layer 2 and the second adhesive layer 5 are made of a same material, the product cost of the touch screen 100 can be reduced.

An embodiment of the invention further provides a display device including the touch screen 100 according to any one of the above embodiments. The display device has advantages of small thickness, low cost and good image display quality.

The display device includes but is not limited to a mobile phone, a laptop computer, a tablet PC, a POS machine, an automotive computer and a camera.

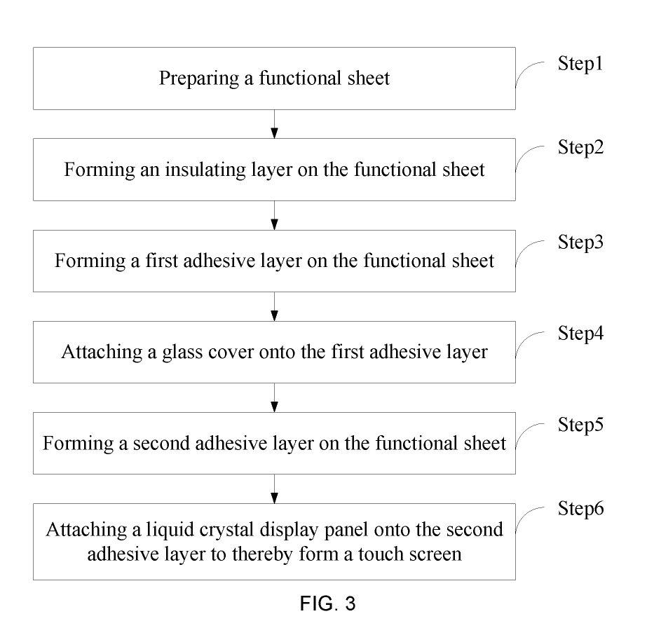

Referring to FIG. 1 through FIG. 3 together, an embodiment of the invention further provides a manufacturing method of a touch screen. The manufacturing method includes the following step 1 through step 6.

Step 1: preparing a functional sheet (e.g., sensor) 3. The functional sheet 3 includes a first surface 31 and a second surface disposed opposite to each other and both having electrically conductive function. The functional sheet 3 is defined with a window area (or referred to as viewing area) 301 and a wiring area 302 disposed surrounding the window area 301.

Step 2: forming an insulating layer 4 on the second surface 32. The insulating layer 4 is disposed covering the wiring area 302.

Step 3: forming a first adhesive layer 2 on the first surface 31.

Step 4: attaching a glass cover 4 onto a surface of the first adhesive layer 2 facing away from the first surface 31.

Step 5: forming a second adhesive layer 5 on the second surface 32 and the insulating layer 4.

Step 6: attaching a liquid crystal display panel 6 onto a surface of the second adhesive layer 5 facing away from the second surface 32 and thereby forming a touch screen 100.

In the illustrated embodiment, the insulating layer 4 covers the wiring area 302 but exposes the window area 301, so that wires of the functional sheet 3 are completely isolated from outside, product reliability of the touch screen 100 is improved and the window area 310 can achieve advantages of high light transmittance and good display image quality. Meanwhile, because the thickness of the insulating layer 4 can be controlled in a very thin range, the overall thickness of the touch screen 100 is reduced, which facilitates the touch screen 100 to be light weight and slim. Moreover, the insulating layer 4 has a low cost, which can effectively reduce the product cost of the touch screen 100.

Further, as an alternative embodiment, the step 1 may include step 11 through step 13 as follows.

Step 11: providing a PET (polyethylene terephthalate, its chemical formula is COC6H4COOCH2CH2O) substrate 34, and the PET substrate 34 being a rolled base material.

Step 12: forming a patterned first metal mesh layer 33 on a side of the PET substrate 34 in a roll-to-roll manner, the first metal mesh layer 33 having a first surface 31.

Step 13: forming a patterned second metal mesh layer 35 on another side of the PET substrate 34 in a roll-to-roll manner, the second metal mesh layer 35 having a second surface 32.

In the illustrated embodiment, the roll-to-roll method can make the functional sheet 3 be processed in batches and low-cost. It should be understood that, prepared by the step 1 is a rolled functional sheet and thus each roll has multiple functional sheets 3.

Still further, as an alternative embodiment, the step 2 may include step 21 and step 22.

Step 21: printing a patterned insulating layer coating on the second surface 32 in a roll-to-roll manner.

Step 22: solidifying the insulating layer coating to thereby form the insulating layer 4.

In the illustrated embodiment, by using the roll-to-roll printing method, the patterned insulating layer 4 can be directly formed on the second surface 32 and thus can be continuously processed in batches and further have high processing accuracy and low cost. Preferably, in the step 22, an ultraviolet (UV) light irradiation can be used to solidify the insulating layer coating.

Preferably, a thickness range of the insulating layer 4 is from 5 μm to 10 μm.

Even still further, as an alternative embodiment, a step may be provided between the step 2 and the step 3 as follows:

cutting the rolled functional sheet to form sheet-shaped functional sheets and each sheet-shaped functional sheet including multiple functional sheets 3.

Moreover, as an alternative embodiment, the step 3 may include:

attaching the first adhesive layer 2 onto the first surface 31 in a sheet-by-sheet manner.

In the illustrated embodiment, the use of sheet-by-sheet method can make the first adhesive layer 2 be attached onto multiple functional sheets 3 simultaneously, i.e., can carry out continuous processing in batches and achieve high processing accuracy and low cost.

Furthermore, as an alternative embodiment, steps may be provided between the step 3 and the step 4 as follows:

punching the sheet-shaped function sheet to form individual multiple functional sheets 3;

performing function and appearance checking onto the functional sheet 3;

bonding a flexible printed circuit board onto the functional sheet 3 to form a semi-finished product; and

performing a function checking onto the semi-finished product.

In the illustrated embodiment, the two steps of checking are in favor of improving yield of finished product of the touch screen 100.

In addition, as an alternative embodiment, a step may be provided between the step 4 and the step 5 as follows:

performing appearance and function checking onto the finished product prepared by the step 4.

In the illustrated embodiment, the checking step is in favor of improving yield of finished product of the touch screen 100.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A touch screen comprising:
a glass cover;
a functional sheet, comprising a first surface and a second surface disposed opposite to each other and both having electrically conductive function, wherein the first surface is attached to the glass cover by a first adhesive layer, the functional sheet is defined with a window area and a wiring area disposed surrounding the window area;
an insulating layer, disposed on the second surface and covering the wiring area; and
a liquid crystal display panel, wherein the liquid crystal display panel is attached to both the second surface and the insulating layer by a second adhesive layer.

2. The touch screen as claimed in claim 1, wherein a thickness of the insulating layer is less than or equal to 10 μm.

3. The touch screen as claimed in claim 2, wherein the thickness of the insulating layer is greater than or equal to 5 μm.

4. The touch screen as claimed in claim 1, wherein the functional sheet comprises a first metal mesh layer, a PET substrate and a second metal mesh layer sequentially stacked in that order.

5. The touch screen as claimed in claim 1, wherein the first adhesive layer and the second adhesive layer each are made of an optically clear adhesive material.

6. A display device comprising a touch screen, the touch screen comprising:
a glass cover;
a functional sheet, comprising a first surface and a second surface disposed opposite to each other and both having electrically conductive function, wherein the first surface is attached to the glass cover by a first adhesive layer, the functional sheet is defined with a viewing area and a wiring area disposed surrounding the viewing area;
an insulating layer, disposed on the second surface and covering the wiring area; and
a liquid crystal display panel, wherein the liquid crystal display panel is attached to both the second surface and the insulating layer by a second adhesive layer.

7. The display device as claimed in claim 6, wherein a thickness of the insulating layer is less than or equal to 10 μm.

8. The display device as claimed in claim 7, wherein a thickness of the insulating layer is greater than or equal to 5 μm.

9. The display device as claimed in claim 6, wherein the functional sheet comprises a first metal mesh layer, a PET substrate and a second metal mesh layer sequentially stacked in that order.

10. The display device as claimed in claim 6, wherein the first adhesive layer and the second adhesive layer are made of an optically clear adhesive material.

11. A manufacturing method of a touch screen, comprising:
preparing a functional sheet, wherein the functional sheet comprises a first surface and a second surface disposed opposite to each other and both having electrically conductive function, the functional sheet is defined with a window area and a wiring area surrounding the window area;
forming an insulating layer on the second surface, wherein the insulating layer is disposed covering the wiring area;
forming a first adhesive layer on the first surface;
attaching a glass cover on a surface of the first adhesive layer facing away from the first surface;
forming a second adhesive layer on the second surface and the insulating layer; and
attaching a liquid crystal display panel on a surface of the second adhesive layer facing away from the second surface to thereby form a touch screen.

12. The manufacturing method of a touch screen as claimed in claim 11, wherein the step of “preparing a functional sheet, wherein the functional sheet comprises a first surface and a second surface disposed opposite to each other and both having electrically conductive function” comprises:
providing a PET substrate;
forming a patterned first metal mesh layer on a side of the PET substrate in a roll-to-roll manner, wherein the first metal mesh layer has the first surface; and
forming a patterned second metal mesh layer on another side of the PET substrate in a roll-to-roll manner, wherein the second metal mesh layer has the second surface.

13. The manufacturing method of a touch screen as claimed in claim 11, wherein the step of “forming an insulating layer on the second surface” comprises:
printing a patterned insulating layer coating on the second surface in a roll-to-roll manner; and
solidifying the insulating layer coating to form the insulating layer.

14. The manufacturing method of a touch screen as claimed in claim 11, wherein the step of “forming a first adhesive layer on the first surface” comprises:
attaching the first adhesive layer onto the first surface in a sheet-by-sheet manner.
